(19) United States
(12) Patent Application Publication
(10) Pub. No.: US 2016/0161664 A1
(43) Pub. Date: Jun. 9, 2016

(54) DISPLAY APPARATUS

(71) Applicant: SHARP KABUSHIKI KAISHA, Osaka (JP)

(72) Inventors: Takeshi ISHIDA, Osaka-shi (JP); Ryuzo YUKI, Osaka-shi (JP); Hisashi WATANABE, Osaka-shi (JP)

(21) Appl. No.: 14/903,067

(22) PCT Filed: Aug. 6, 2014
(86) PCT No.: PCT/JP2014/070670

§ 371 Date: Jan. 6, 2016

(30) Foreign Application Priority Data
Aug. 12, 2013 (JP) 2013-167344

(51) Int. Cl. F21V 8/00; G02B 26/04

(52) U.S. Cl. CPC G02B 6/0061; G02B 26/04; G02B 6/0053; G02B 6/0088

(57) ABSTRACT

The present invention reduces brightness unevenness at the periphery of a non-display region in a display device that uses an edge-type backlight by means of a display device being provided with a liquid crystal panel, a light guide plate, which has the surface opposing the liquid crystal panel as the light emitting surface and one lateral surface other than the light emitting surface and the surface opposite the light emitting surface as the light incident surface, a light source unit, which opposes the light incident surface, and an opening that pierces the light guide plate from the light emitting surface to the surface opposite the light emitting surface, the configuration being such that the length (X) from the light incident surface to the center of the opening is at least ½ the length (L) from the light incident surface to the lateral surface opposite the light incident surface.

### TECHNICAL FIELD

The present invention relates to a display apparatus having a non-display region, such as a window portion, within a display region.

### BACKGROUND ART

Display apparatuses employing optical shutter devices, such as liquid crystal panels and micro electro mechanical systems (MEMS), are provided with backlights, among which side incident type (edge type) backlights are preferred to meet the recent demand for thinner display apparatuses. And as an application of such display apparatuses, there has been proposed a display apparatus where a transparent window portion (a non-display region) is formed in part of a display region.

For example, Patent Literature 1 listed below discloses a way of leading gate signal lines and drain signal lines for forming a non-display region.

### CITATION LIST

### Patent Literature

Patent Literature 1: Japanese Patent Application Publication No. 2009-47902

### SUMMARY OF INVENTION

### Technical Problem

However, the disclosure of Patent Literature 1 does not include a backlight. For example, in a case where an edge type backlight is employed, disadvantageous unevenness occurs in brightness around a non-display region. Specifically, brightness is higher around light-source-side part of the non-display region and lower around part of the non-display region opposite from the light-source-side part of the non-display region. On the other hand, in a case where a direct backlight is employed, the display apparatus becomes disadvantageously thick.

In view of the above problems, an object of the present invention is to provide a display apparatus employing an edge type backlight with reduced uneven brightness around a non-display region.

### Solution to Problem

To achieve the above object, according to an aspect of the present invention, a display apparatus includes an optical shutter device, a light guide plate having a light emitting surface facing the optical shutter device and a light incident surface that is one of side surfaces that include neither the light emitting surface nor a surface opposing the light emitting surface, a light source facing the light incident surface, and an opening portion penetrating the light guide plate from the light emitting surface through the surface opposing the light emitting surface. Here, a length from the light incident surface to a center of the opening portion is equal to or longer than half a length from the light incident surface to a side surface opposing the light incident surface.

### Advantageous Effects of Invention

According to the present invention, in a display apparatus employing an edge type backlight, it is possible to reduce uneven brightness around a non-display region by disposing an opening portion that constitutes the non-display region as far as possible from a light source.

### BRIEF DESCRIPTION OF THE DRAWINGS

FIG. 1 is a top view of a display apparatus of a first embodiment of the present invention;

FIG. 2 is a top view illustrating a configuration of a principal portion of a display section in the display apparatus of the first embodiment of the present invention;

FIG. 3 is an example of a sectional view taken along line A-A of FIG. 2;

FIG. 4 is a diagram illustrating brightness distribution in the display section in the display apparatus of the first embodiment of the present invention;

rated in Figdiagram illustrating an image of brightness distribution in a display section in a display apparatus of a comparative example;

FIG. 6 is a sectional view illustrating a configuration of a principal portion of a display section in a display apparatus of a second embodiment of the present invention;

FIG. 7 is a sectional view illustrating a configuration of a principal portion of a display section in a display apparatus of a third embodiment of the present invention;

FIG. 8 is a sectional view illustrating a configuration of a principal portion of a display section in a display apparatus of a fourth embodiment of the present invention;

FIG. 9 is a top view illustrating a configuration of a principal portion of a display section in a display apparatus of a fifth embodiment of the present invention;

FIG. 10 is a graph illustrating density of a light extraction pattern between points a and b of FIG. 9;

FIG. 11 is a graph illustrating results of measurement of brightness in the display apparatus of the fifth embodiment of the present invention;

FIG. 12 is a top view illustrating a configuration of a principal portion of a display section in a display apparatus of a sixth embodiment of the present invention;

FIG. 13 is a graph illustrating density of a light extraction pattern between points c and d of FIG. 12;

FIG. 14 is a graph plotted by taking X1/L of Table 1 on the horizontal axis and R of Table 1 on the vertical axis;

FIG. 15 is a sectional view illustrating a configuration of a principal portion of a display section in a display apparatus of a seventh embodiment of the present invention;

FIG. 16 is an exploded perspective view of a backlight and a backlight chassis of the seventh embodiment of the present invention;

FIG. 17 is a top view of a case where a camera and a proximity sensor are mounted in a non-display region of the display apparatus of the seventh embodiment of the present invention;

FIG. 18 is a top view of a conventional display apparatus;

FIG. 19 is a top view of a display apparatus of an eighth embodiment of the present invention;

FIG. 20 is a sectional view taken along line B-B of FIG. 19, illustrating a configuration of a principal portion;

FIG. 21 is a sectional view illustrating a configuration of a principal portion of a display section in a display apparatus of a ninth embodiment of the present invention;

FIG. 22 is a sectional view illustrating a configuration of a principal portion of a display section in a display apparatus of a tenth embodiment of the present invention;

FIG. 23 is a see-through top view illustrating vicinity of a light blocking layer of an eleventh embodiment of the present invention;

FIG. 24 is a sectional view taken from FIG. 23;

FIG. 25 is a see-through top view illustrating vicinity of a light blocking layer of another example of the eleventh embodiment of the present invention; and

FIG. 26 is a sectional view taken from FIG. 25.

### DESCRIPTION OF EMBODIMENTS

Embodiments of the present invention will be described below with reference to accompanying drawings. The following descriptions of embodiments will deal with liquid crystal display apparatuses as examples of a display apparatus. The display apparatus of the present invention is not limited to liquid crystal display apparatuses, and the present invention is applicable also to display apparatuses employing other optical shutter devices such as micro electro mechanical systems (MEMS). Portions, members, and components common to the embodiments are denoted by the same reference signs, and the overlapping descriptions thereof will be omitted. The embodiments may be appropriately combined with each other within a possible range.

### First Embodiment

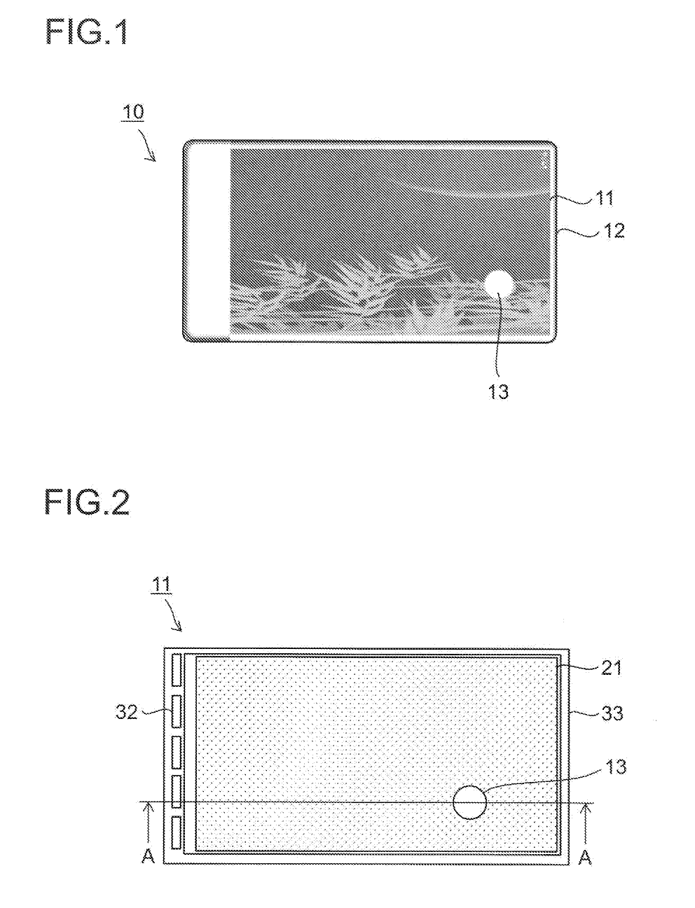

FIG. 1 is a top view of a display apparatus of a first embodiment. The display apparatus 10 is a smart phone, and includes a display section 11 and a housing 12 surrounding the display section 11. In part of the display section 11, there is formed a non-display region 13 where no image is displayed. Here, there is no limitation to the number of the non-display region 13, and two or more non-display regions 13 may be formed.

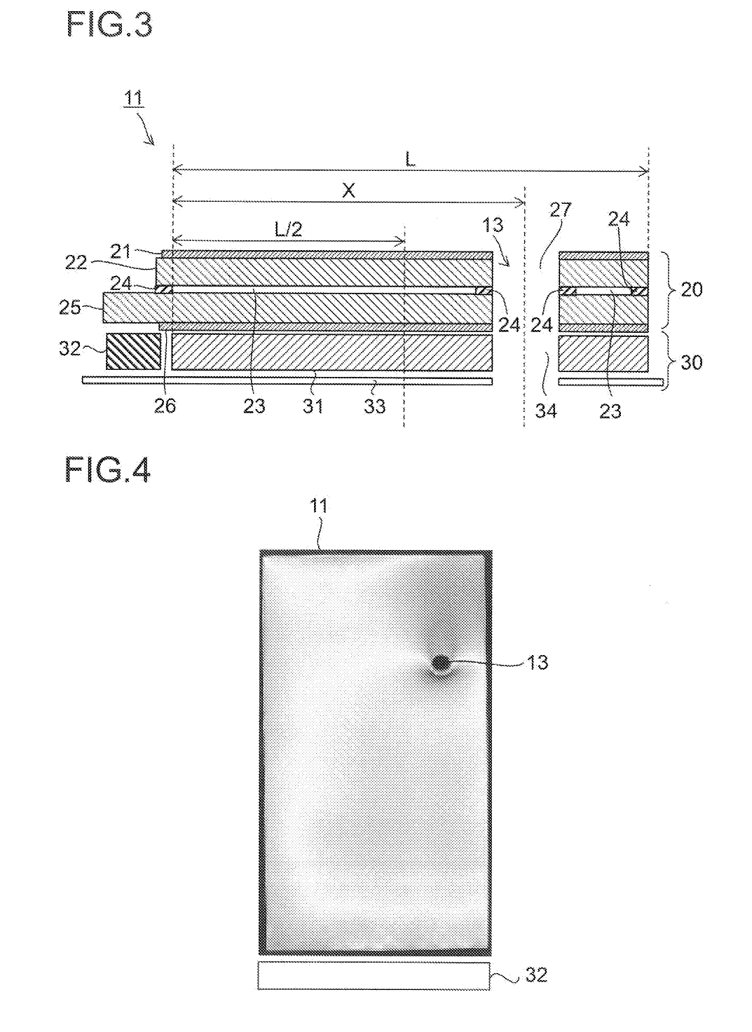

FIG. 2 is a top view illustrating a configuration of a principal portion of the display section 11, and FIG. 3 is an example of a sectional view taken along line A-A of FIG. 2. The display section 11 includes a liquid crystal panel 20 as a shutter device and an edge type backlight 30.

The liquid crystal panel 20 includes an upper polarization plate 21, an upper substrate 22, a liquid crystal layer 23 and a seal member 24 sealing the liquid crystal layer 23, a lower substrate 25, the upper and lower substrates 22 and 25 sandwiching the liquid crystal layer 23 therebetween, and a lower polarization plate 26, which are stacked in this order from a display-surface side.

Thus, the liquid crystal panel 20 includes two transparent substrates (the upper and lower substrates 22 and 25) between which a liquid crystal element (the liquid crystal layer 23) is filled, and by the liquid crystal element being driven and the backlight 30 being illuminated, an image is displayed on the liquid crystal panel 20.

The liquid crystal panel 20 includes a hole portion 27 located in the non-display region 13. The hole portion 27 penetrates the liquid crystal panel 20 in an up-down direction, and faces an opening portion 34 of a light guide plate 31, which will be described later. The hole portion 27 is illustrated as circular-shaped in the top view of FIG. 2, but there is no limitation to the shape of the hole portion 27, and the hole portion 27 may be formed in any shape, such as an elliptical shape, a rectangular shape, a square shape, other polygon shapes, and other curved shapes.

The backlight 30 includes a light guide plate 31, a light source unit 32, and a reflection sheet 33. Here, various optical sheets may be provided on the light guide plate 31 (between the light guide plate 31 and the lower polarization plate 26) as necessary. The term “optical sheet” generally refers to a prism sheet, a diffusion sheet, and the like, and combinations of one or a plurality of such optical sheets. For example, the optical sheet may be composed of two prism sheets and a diffusion sheet stacked in this order from the top.

The light guide plate 31 is a member that converts light incident on its light incident surface into surface light and emits the surface light through its light emitting surface. The light guide plate 31 is rectangular parallelepiped, for example, and has a light emitting surface that faces the liquid crystal panel 20, a surface opposing the light emitting surface, and four side surfaces connecting these two surfaces. One of the four side surfaces (in FIG. 2, one on a short-side side) is a light incident surface that faces the light source unit 32. The light guide plate 31 is preferably made of resin, such as acrylics and polycarbonate (PC), to reduce thickness and weight of the light guide plate 31.

The light source unit 32 is disposed to face the light incident surface of the light guide plate 31. This arrangement of the light source unit 32 is called an edge type, and is more advantageous than a direct type to achieve reduced thickness. The light source unit 32 includes a light emitting diode (LED) which is a point light source, and an LED substrate on which the LED is mounted. Here, as a light source, for example, a fluorescence tube, which is a linear light source, may be used instead of the LED. A plurality of LEDs are arranged on the LED substrate at predetermined intervals along one side surface of the light guide plate 31. As the LED substrate, a metal substrate such as an aluminum substrate is often used for heat dissipation and strength, and a flexible printed substrate made based on a polyimide film is also often used to achieve a lightweight light source unit.

The reflection sheet 33 is disposed on the side of the surface of the light guide plate 31 opposing the light emitting surface. Inside the light guide plate 31, the reflection sheet 33 reflects light that has reached the surface opposing the light emitting surface, and this helps improve the light emitting efficiency of the light guide plate 31.

Furthermore, the backlight 30 includes the opening portion 34 located in the non-display region 13. That is, the opening portion 34 faces (overlaps with) the hole portion 27. The opening portion 34 penetrates the light guide plate 31 and the reflection sheet 33 in the up-down direction in FIG. 3. That is, the opening portion 34 penetrates the light guide plate 31 from the light emitting surface through the surface opposing the light emitting surface. The opening portion 34 is illustrated as circular-shaped in the top view of FIG. 2, but there is no limitation to the shape of the opening portion 34, and the opening portion 34 may have any shape, such as an elliptical shape, a rectangular shape, a square shape, other polygon shapes, and other curved shapes, but it is preferable that the opening portion 34 has the same shape as the hole portion 27. Thus, with the opening portion 34 and the hole portion 27 continuous with each other and together forming the non-display region 13 penetrating the liquid crystal panel 20 and the backlight 30, the non-display region 13 has a most preferable transmitting characteristic.

As illustrated in FIG. 3, a length X from the light incident surface to a center of the non-display region 13 (the opening portion 34 and the hole portion 27) is equal to or larger than half a length L from the light incident surface to a side surface opposing the light incident surface (X≧L/2). This is intended for the purpose of disposing the non-display region 13 as far away from the light source unit 32 as possible. Thus, the relationship between the lengths X and L may also be X≧3L/5, X≧7L/10, X≧4L/5, or X≧9L/10, for example.

FIG. 4 is a diagram illustrating an image of brightness distribution in the display section 11 in the display apparatus 10 of the present embodiment, and FIG. 5 is a diagram illustrating an image of brightness distribution in a display section in a display apparatus of a comparative example. In FIGS. 4 and 5, black circles each indicate a non-display region, and the brightness distribution is illustrated such that lighter shades represent higher brightness while darker shades represent lower brightness.

In the display section 11 of FIG. 4, there is hardly any uneven brightness except that brightness is slightly higher in the vicinity of light-incident-surface-side part of the non-display region 13 than in part therearound, and that brightness is slightly lower in the vicinity of surface-opposing-the-light-incident-surface-side part of the non-display region 13 than in part therearound. This is presumably because the amount of light around the non-display region 13 is within the range of light amount that the light guide plate 31 can handle.

On the other hand, the display apparatus of the comparative example illustrated in FIG. 5 has two non-display regions 130, and they are disposed near a light source unit 32 (X<L/2). In a display section 110 in this display apparatus, brightness is significantly higher in the vicinity of light-incident-surface-side part of each of the non-display regions 130 than in part therearound, while brightness is significantly lower in the vicinity of surface-opposing-the-light-incident-surface-side part of each of the non-display regions 130 than in part therearound, and thus brightness is significantly uneven over the entire display section. This is presumably because the amount of light around each of the non-display regions 130 is so large that it is out of the range of light amount that the light guide plate 31 can handle.

The configurations of FIGS. 4 and 5 are different from each other in the length from the light source unit to the non-display region, and thus, it can be concluded that uneven brightness is unlikely to occur when the length X from the light incident surface of the light guide plate 31 to the non-display region 13 is long, specifically, X≧L/2, as in the display section 10 of the present embodiment.

Thus, according to the display apparatus 10 employing the edge type backlight 31 of the present embodiment, since X≧L/2 is satisfied, uneven brightness around the non-display region 13 can be reduced.

### Second Embodiment

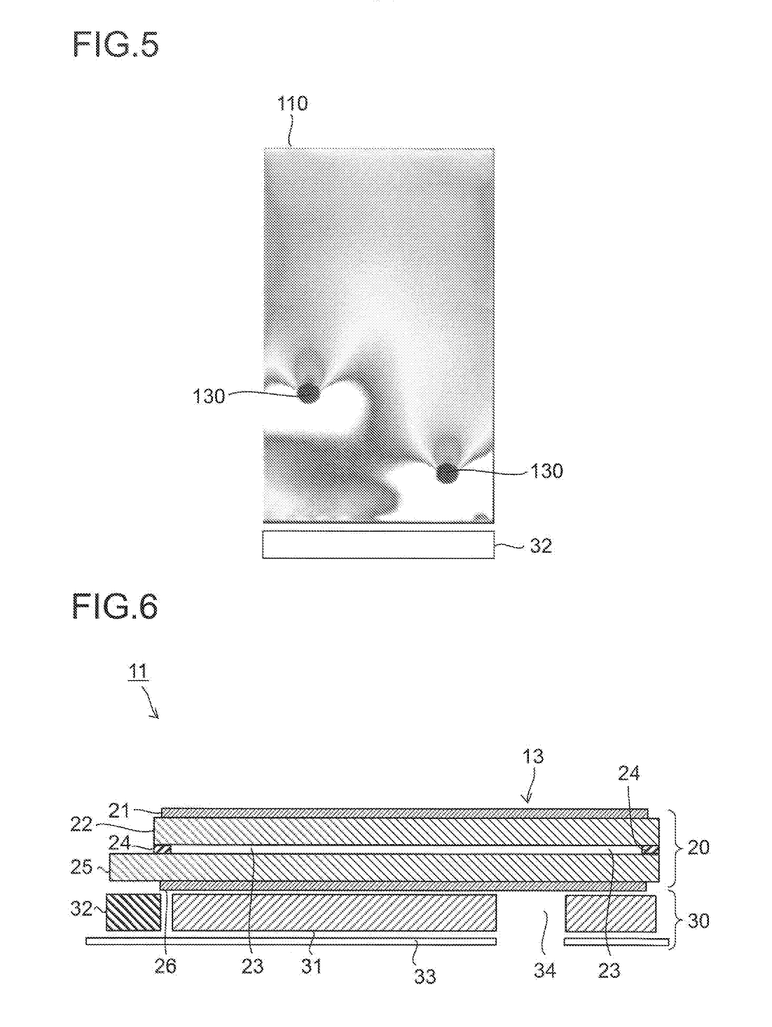

FIG. 6 is a sectional view illustrating a configuration of a principal portion of a display section in a display apparatus of a second embodiment. The second embodiment is different from the first embodiment in that no hole portion 27 is provided in the second embodiment, but in other respects, the second embodiment is configured in a manner similar to the first embodiment.

As illustrated in FIG. 6, no hole portion is formed in a liquid crystal panel 20. To obtain a transmitting characteristic, in the liquid crystal panel 20, part facing an opening portion 34 has a normally white structure (that becomes transparent when voltage is applied thereto) or structured to be made transparent by application of voltage. With such a configuration, too, a non-display region 13 has a transmitting characteristic as in the first embodiment. Thus, in the second embodiment, too, the same operation effect can be achieved as in the first embodiment.

### Third Embodiment

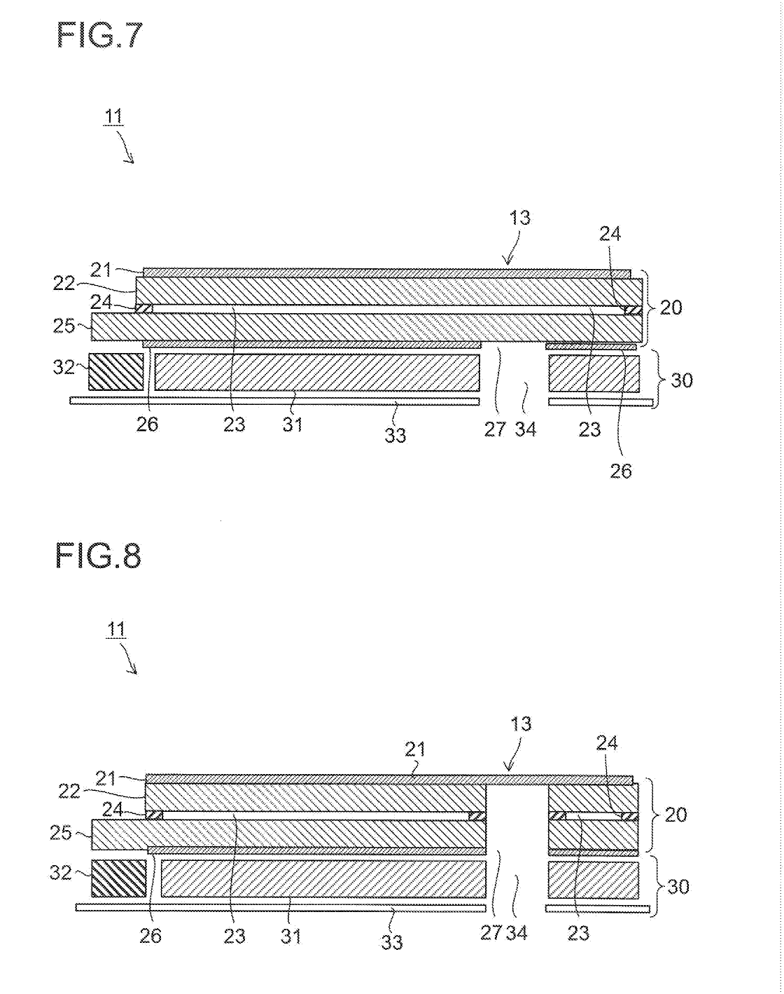

FIG. 7 is a sectional view illustrating a configuration of a principal portion of a display section in a display apparatus of a third embodiment. The third embodiment is different from the first embodiment in that a hole portion 27 is formed only in a lower polarization plate, but in other respects, the third embodiment is configured in a manner similar to the first embodiment.

As illustrated in FIG. 7, the hole portion 27 is formed in the lower polarization plate 26 to penetrate part of the lower polarization plate 26 facing an opening portion 34. As in the second embodiment, in the present embodiment, too, to obtain a transmitting characteristic, in a liquid crystal panel 20, part facing the opening portion 34 has a normally white structure (that becomes transparent when voltage is applied thereto) or structured to be made transparent by application of voltage. With such a configuration, too, a non-display region 13 has a transmitting characteristic as in the first embodiment. Thus, in the third embodiment, too, the same operation effect can be achieved as in the first embodiment.

### Fourth Embodiment

FIG. 8 is a sectional view illustrating a configuration of a principal portion of a display section in a display apparatus of a fourth embodiment. The fourth embodiment is different from the first embodiment in that a hole portion 27 is formed in a liquid crystal panel 20 except in an upper polarization plate 21, but in other respects, the fourth embodiment is configured in a manner similar to the first embodiment.

As illustrated in FIG. 8, a hole portion 27 is formed in the liquid crystal panel 20 to penetrate part thereof facing an opening portion 34 excluding the upper polarization panel 21. With such a configuration, too, a non-display region 13 has a transmitting characteristic as in the first embodiment. Thus, in the third embodiment, too, the same operation effect can be achieved as in the first embodiment.

### Fifth Embodiment

In a display apparatus of a fifth embodiment, a light extraction pattern that improves light extraction efficiency is disposed on a light emitting surface or on a surface opposing the light emitting surface of a light guide plate. Density of the light extraction pattern is higher in the vicinity of side-surface-opposing-a-light-incident-surface-side part of an opening portion 34 than in part therearound. In other respects, the fifth embodiment is configured in a manner similar to the first embodiment.

The light extraction pattern is formed of a plurality of dots, for example, and helps improve light extraction efficiency by diffusing light inside a light guide plate mainly by reflection. The dots can each be circular-shaped, for example, and are formed, for example, by inkjet printing with a white paint containing a small amount of diffusion material and the like, for example.

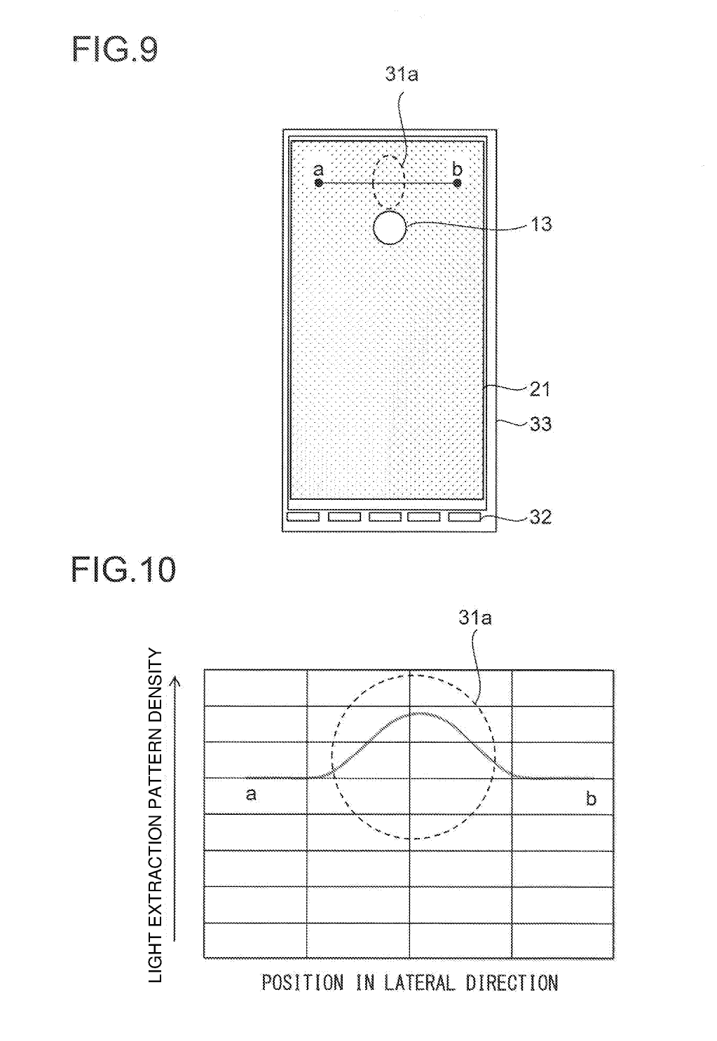

FIG. 9 is a top view illustrating a configuration of a principal portion of a display section of the display apparatus of the fifth embodiment. In FIG. 9, in a light guide plate 31, a region 31a surrounded by a broken line is a region in the vicinity of the side-surface-opposing-the-light-incident-surface-side part of the opening portion 34 (the non-display region 13). FIG. 10 is a graph illustrating density of the light extraction pattern between points a and b of FIG. 9. The figure indicates that the density of the light extraction pattern is higher in the region 31a than in part around the region 31a.

The density of the light extraction pattern in the region 31a can be determined in the following manner, for example. First, by using light guide plates each having a length L from the light incident surface to the side surface opposing the light incident surface is 115 mm, there were prepared three samples each having a circular opening portion with a diameter of 5.5 mm, and one sample without an opening portion (REF.). The opening portions in the three samples were positioned such that lengths X from the light incident surfaces of the light guide plates 31 to centers of the opening portions 34 were respectively 85 mm, 100 mm, and 105 mm. These four samples had no light extraction pattern formed thereon. Then, with respect to each of these four samples, brightness was measured over the light guide plate from the light incident surface in a direction of the side surface opposing the light incident surface.

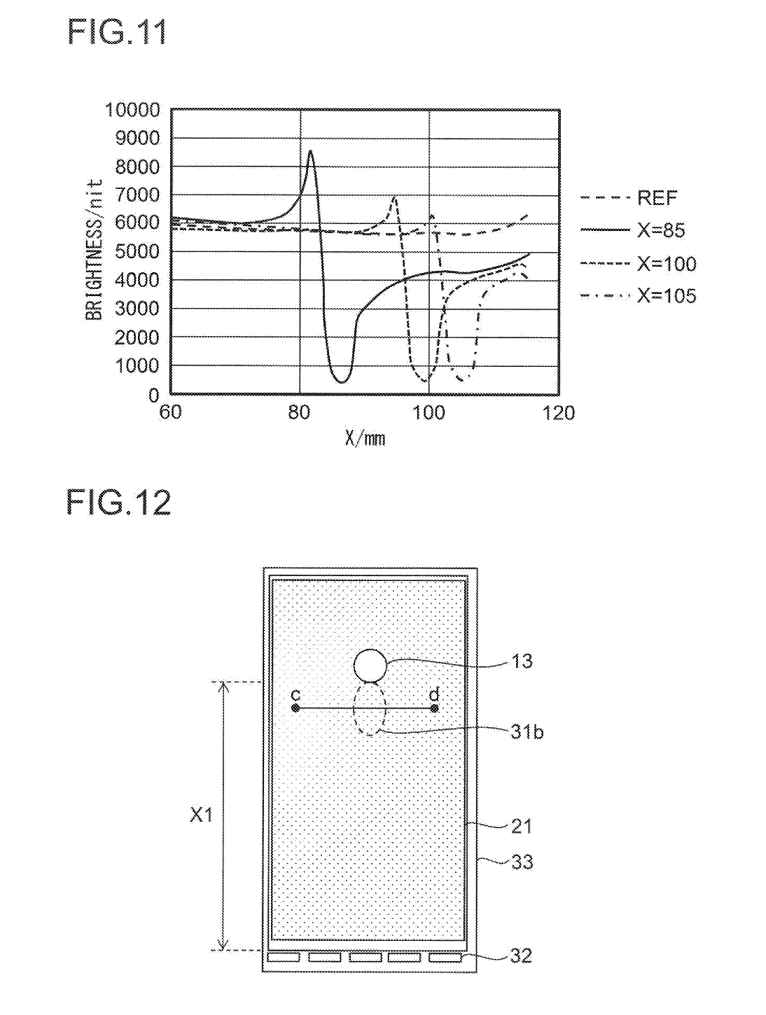

The results of the measurement of brightness are indicated in FIG. 11. The results have shown that in each of the three samples respectively having the opening portions 34 formed at different positions, brightness in the vicinity of the side-surface-opposing-the-light-incident-surface-side part of the opening portion 34 (the region 31a) was reduced to about ⅔ of the brightness in the corresponding region of the REF. sample. Here, evenness of brightness required of commonly used light guide plates is 80% or higher. Thus, the density of the light extraction pattern designed so as to make the brightness in the region 31a 80% or higher of the brightness in part surrounding the region 31a is expressed by the following formula:

D_{A}≧D_{A0}×0.8/(⅔)=1.2D_{A0}

where

D_{A} represents the density of the light extraction pattern in the region 31a, and

D_{A0} represents the density of the light extraction pattern at a position around the region 31a located at the same distance as the region 31a from the light incident surface.

That is, the density of the light extraction pattern DA in the region 31a is to be 1.2 times the density of the light extraction density D_{A0} therearound or higher. With this design, it is possible to improve the light extraction efficiency in the region 31a, and thus to reduce uneven brightness in the vicinity of the side-surface-opposing-the-light-incident-surface-side part of the opening portion 34 to a level insignificant in practical use.

### Sixth Embodiment

In a display apparatus of a sixth embodiment, a light extraction pattern that improves the light extraction efficiency is disposed on a light emitting surface or a surface opposing the light emitting surface of a light guide plate. Density of the light extraction pattern is lower in the vicinity of light-incident-surface-side part of an opening portion 34 than in part therearound. In other respects, the sixth embodiment is configured in a manner similar to the first embodiment. The sixth embodiment is similar to the fifth embodiment in shape, material, and manufacturing method of the light extraction pattern.

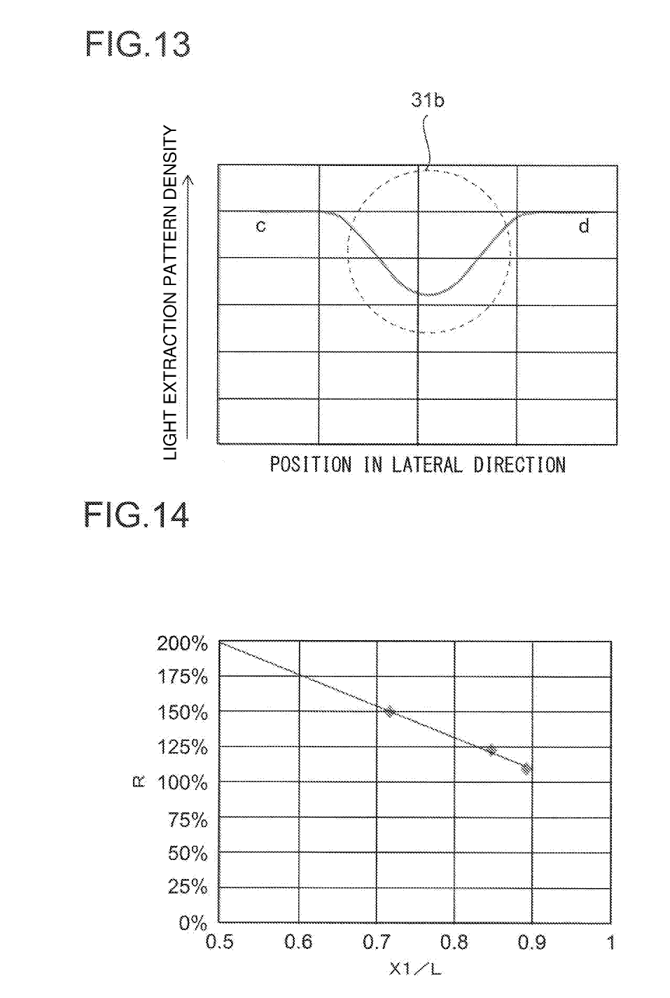

FIG. 12 is a top view illustrating a configuration of a principal portion of a display section of the display apparatus of the sixth embodiment. In FIG. 12, in a light guide plate 31, a region 31b surrounded by a broken line is a region in the vicinity of the light-incident-surface-side part of the opening portion 34 (a non-display region 13). FIG. 13 is a graph illustrating the density of the light extraction pattern between points c and d of FIG. 12. The figure indicates that the density of the light extraction pattern is lower in the region 31b than in part around the region 31b.

The density of the light extraction pattern in the region 31b can be determined in the following manner, for example. First, values of brightness obtained by the measurement conducted with respect to the fifth embodiment (see FIG. 11) are tabulated in Table 1. Table 1 indicates characteristic values of the three samples. W represents diameter of the opening portion 34, X1 represents length from the light incident surface of the light guide plate 31 to an edge of the opening portion 34 as illustrated in FIG. 12, R represents percentage of brightness in the vicinity of the light-incident-surface-side part of the opening portion 34 (the region 31b) with respect to brightness in the corresponding region of the sample REF.

TABLE 1

| L | W | X | X1(=X − W/2) | | |
|---|---|---|---|---|---|
| (mm) | (mm) | (mm) | (mm) | X1/L | R |
| 115 | 5.5 | 85 | 82.25 | 0.715217391 | 150% |
| 115 | 5.5 | 100 | 97.25 | 0.845652174 | 123% |
| 115 | 5.5 | 105 | 102.25 | 0.889130435 | 110% |

FIG. 14 is a graph plotted by taking X1/L of Table 1 on the horizontal axis and R of Table 1 on the vertical axis. From FIG. 14, there can be derived a formula of R=−2.25(X1/L)+3.11. Thus, the light extraction pattern density designed so as to make the brightness in the region 31b 80% or higher of the brightness in part surrounding the region 31b is expressed by the following formula:

D_{B}≧D_{B0}×0.8÷R=0.8D_{B0}L/(3.11L−2.25X1)

where

D_{B} represents the density of the light extraction pattern in the region 31b, and

D_{B0} represents the density of the light extraction pattern at a position around the region 31b located at the same distance as the region 31b from the light incident surface.

That is, the density of the light extraction pattern is determined corresponding to the position of the opening portion 34 such that the above formula is satisfied. With this design, it is possible to lower the light extraction efficiency in the region 31b, and thus to reduce uneven brightness in the vicinity of the light-incident-surface-side part of the opening portion 34 to a level insignificant in practical use.

### Seventh Embodiment

A display apparatus of a seventh embodiment includes an insertion member inserted in an opening portion 34. The insertion member may be a protrusion portion protruding from a frame (a backlight chassis, an external housing, and the like) where a light guide plate 31 is mounted, for example, or may be an electronic device such as a proximity sensor, a camera, or the like, or may be both a protrusion portion and an electronic device. In the following description, a backlight chassis and a camera are dealt with as an example.

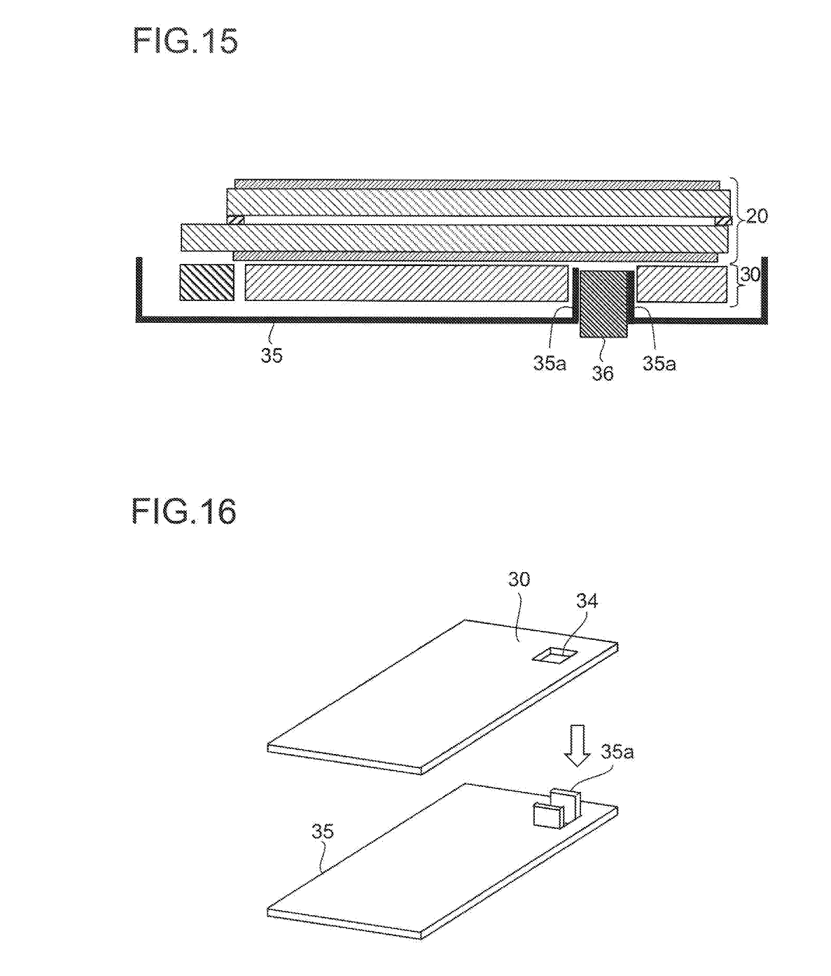

FIG. 15 is a sectional view illustrating a configuration of a principal portion of a display section in the display apparatus of the seventh embodiment of the present invention. The seventh embodiment has a configuration where a backlight chassis 35 and a camera 36 are added to the configuration of the second embodiment. FIG. 16 is an exploded perspective view of a backlight 30 and a back light chassis 35.

As illustrated in FIG. 15 and FIG. 16, the backlight chassis 35 has a protrusion portion 35a formed in part thereof facing an opening portion 34 to protrude toward the opening portion 34. The protrusion portion 35a is composed of, for example, two plate members facing each other. The backlight chassis 35 is a member that serves as a base for mounting (accommodating) each member of the backlight 30. To secure rigidity and heat dissipation characteristic of the backlight chassis, it is desirable for the backlight chassis to be made of a material such as a stainless steel sheet (SUS), aluminum, etc. And at the time of assembly, the backlight 30 is positioned and fixed by the protrusion portion 35a, by the protrusion portion 35a being inserted and fitted in the opening portion 34.

Further, as illustrated in FIG. 15, the camera 36 is also inserted in the opening portion 34. Specifically, the camera 36 has been inserted and fitted in the opening portion 34 and the protrusion portion 35a. Thus, since the opening portion 34 of the light guide plate 31 is filled up with structures of the backlight chassis 35 and the camera 36, it is possible to prevent leakage of light from inside the light guide plate 31 through the opening portion 34.

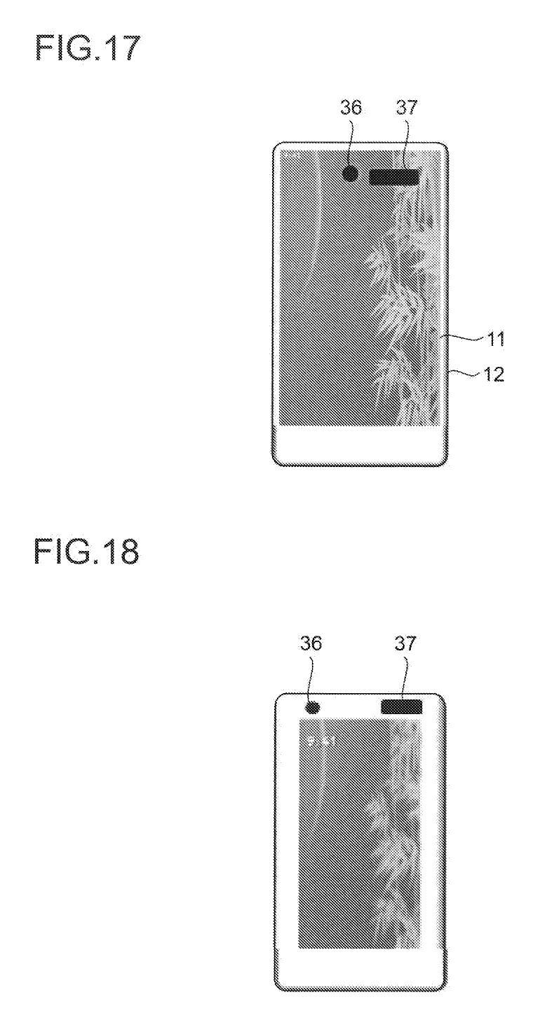

FIG. 17 is a top view of a case where the camera 36 and a proximity sensor 37 are disposed in a non-display region 13 of the display apparatus of the present embodiment, and FIG. 18 is a top view of a conventional display apparatus. When the display apparatus of the present embodiment is compared with the conventional display apparatus of the same size, the display apparatus of the present embodiment has the camera 36 and the proximity sensor 37 mounted in a display section 11, and thus, the display section 11 can be made larger than a display section of the conventional display apparatus. This case is not meant as a limitation, and, in a case where the display section 11 is formed in the conventional size, it is possible to achieve a narrow frame of the display section 11 that is narrower by an amount of space for the camera 36 and the proximity sensor 37, and thus it is possible to achieve a compact display apparatus.

Here, in a configuration having a hole portion 27, the insertion member is inserted in both the opening portion 34 and the hole portion 27. Thereby, it is possible to position and fix a liquid crystal panel 20 and to prevent leakage of light through an end surface of the hole portion 27.

### Eighth Embodiment

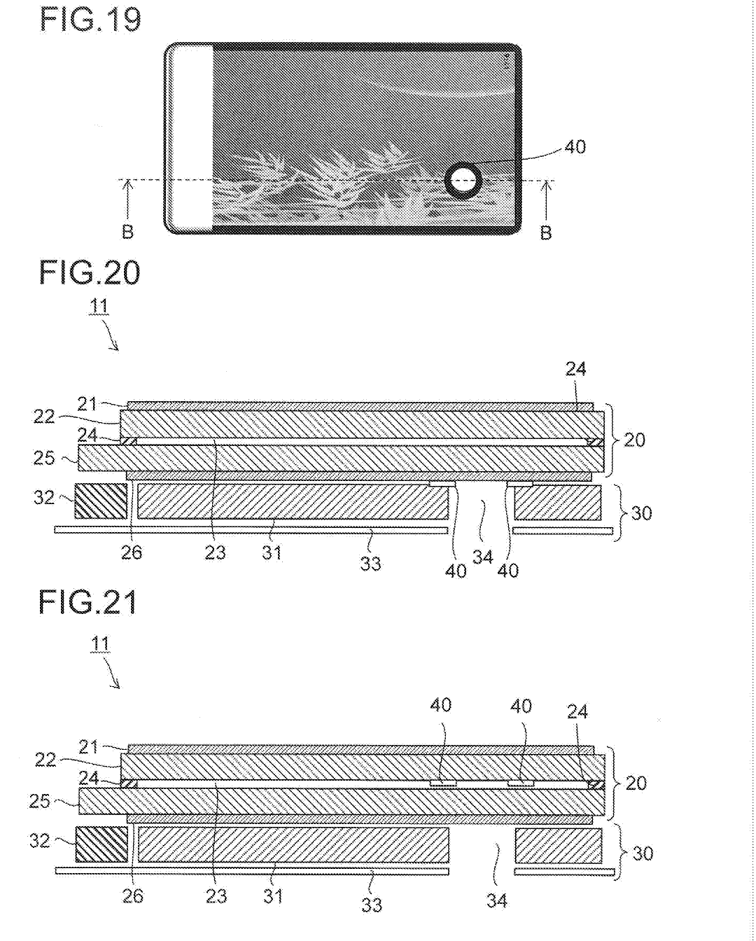

A display apparatus of an eighth embodiment includes a light blocking layer. In other respects, the eighth embodiment is configured in a manner similar to the first embodiment. FIG. 19 is a top view of the display apparatus of the eighth embodiment, and FIG. 20 is sectional view taken along line B-B of FIG. 19, illustrating a configuration of a principal portion.

As illustrated in FIG. 19 and FIG. 20, a light blocking layer 40 is formed by directly bonding a light blocking tape or the like to a light emitting surface of an opening portion 34 of a light guide plate 31. The light blocking layer 40 has a shape corresponding to an opening shape of the opening portion 34, that is, the light blocking layer 40 has a donut-like shape in FIG. 19 and FIG. 20. Further, to effectively block light traveling in an oblique direction, it is preferable that an inner contour of the light blocking layer 40 be smaller than the opening portion 34 and an outer contour of the light blocking layer 40 be larger than the opening portion 40.

With the light blocking layer 40 of the present embodiment, it is possible to make uneven brightness liable to occur around a non-display region 13 unnoticeable by blocking light there, and thus to improve evenness of brightness in a display section 11. Moreover, by the light blocking layer 40 blocking light leaking through the opening portion 34, it is possible to improve display quality with respect to viewing of the display section 11 from an oblique direction.

### Ninth Embodiment

FIG. 21 is a sectional view illustrating a configuration of a principal portion of a display section in a display apparatus of a ninth embodiment. The ninth embodiment is different from the eighth embodiment in position of a light blocking layer 40, but in other respects, the ninth embodiment is configured in a manner similar to the eighth embodiment.

As illustrated in FIG. 21, the light blocking layer 40 is formed inside a liquid crystal panel 20, specifically, on a liquid-crystal-layer-23-side surface of an upper substrate 22, by patterning using a black matrix. With the light blocking layer 40 disposed indirectly on a light-emitting-surface side of the opening portion 34, too, it is possible to block light around the non-display region 13. Thus, in the ninth embodiment, too, it is possible to obtain the same operation effect as in the eighth embodiment.

### Tenth Embodiment

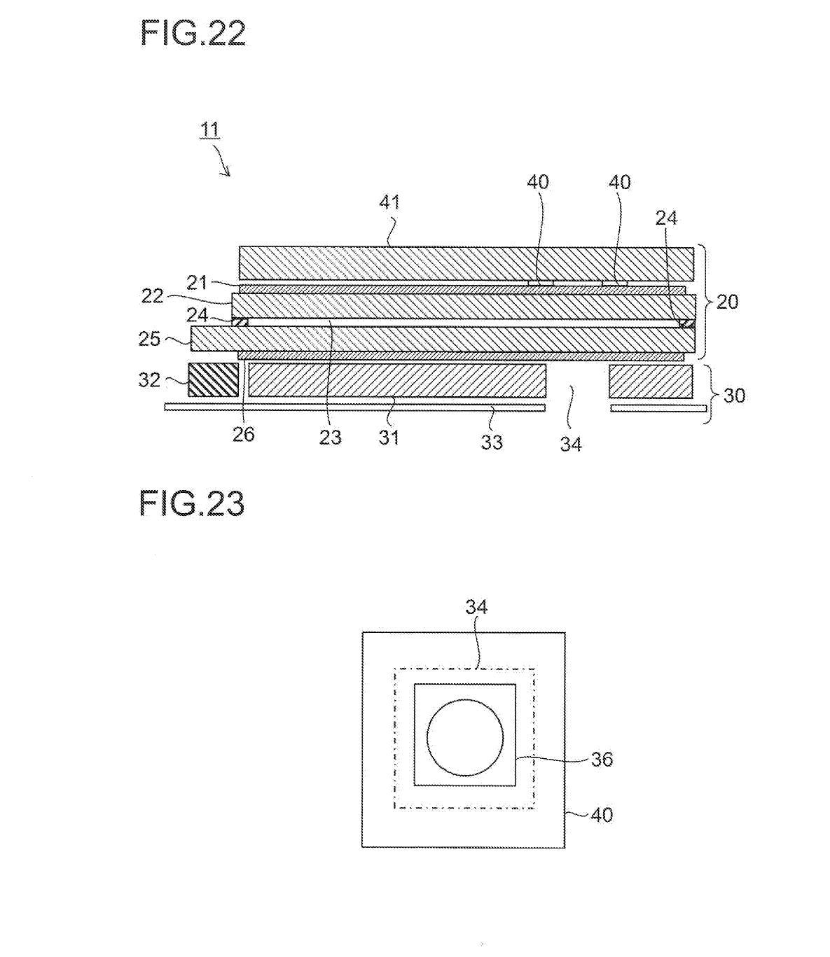

FIG. 22 is a sectional view illustrating a configuration of a principal portion of a display section in a display apparatus of a tenth embodiment. The tenth embodiment is different from the eighth embodiment in position of a light blocking layer 40, but in other respects, the tenth embodiment is configured in a manner similar to the eighth embodiment.

As illustrated in FIG. 22, the light blocking layer 40 is formed by printing on a lower surface of a protection panel 41 that is disposed on an upper surface side in a liquid crystal panel 20. Also with the light blocking layer 40 indirectly on the light-emitting-surface side of the opening portion 34 in this manner, it is possible to block light around a non-display region 13. Thus, in the tenth embodiment, too, it is possible to obtain the same operation effect as in the eighth embodiment.

Here, in the case where the light blocking layer 40 is disposed indirectly on the light-emitting-surface side of the opening portion 34, the same operation effect can also be obtained when the light blocking layer 40 is disposed between layers different from those in the ninth and tenth embodiments.

### Eleventh Embodiment

A display apparatus of an eleventh embodiment includes a light blocking layer, and also includes an electronic device disposed in an opening portion 34. A description given below will deal with an example where a light blocking layer 40 is disposed between the same layers as in the display apparatus of the ninth embodiment (see FIG. 21).

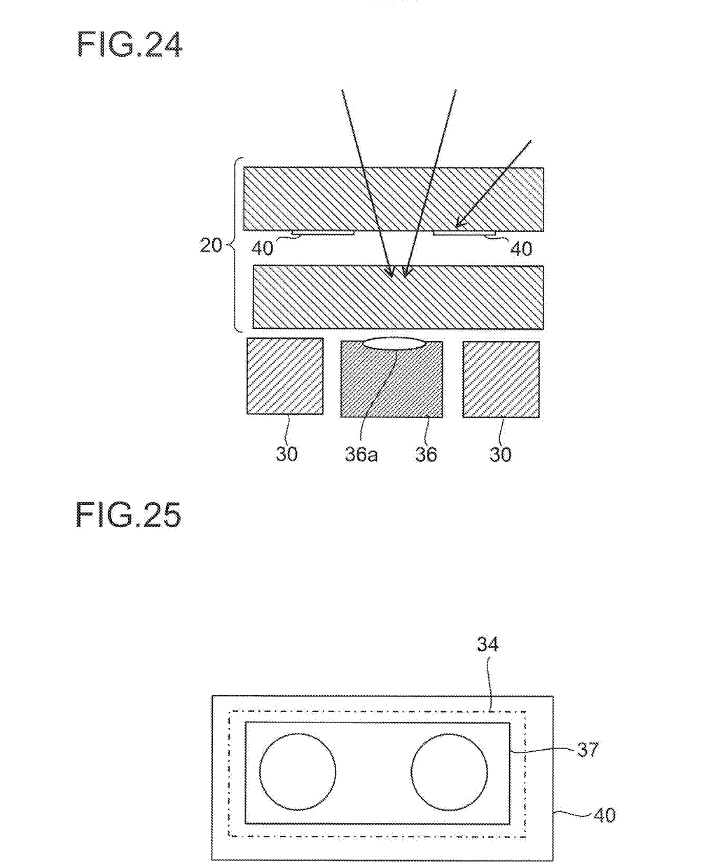

FIG. 23 is a see-through top view illustrating vicinity of the light blocking layer of the present embodiment, and FIG. 24 is a sectional view taken from FIG. 23. As illustrated in FIG. 23 and FIG. 24, the light blocking layer 40 has a square outer contour and a circular inner contour, and a camera 36 is disposed in the opening portion 34 of the light guide plate 31. The outer contour of the light blocking layer 40 is larger than the opening portion 34. On the other hand, the inner contour of the light blocking layer 40 is smaller than the opening portion 34, and further, the inner contour of the light blocking layer 40 is smaller than the outer contour of the camera 36; specifically, the inner contour of the light blocking layer 40 is the same size as a lens 36a of the camera 36.

With such a configuration, as indicated by arrows in FIG. 24, external light is partially blocked by the light blocking layer 40 and is also partially allowed to pass through an opening of the light blocking layer 40 to be incident on the lens 36a of the camera 36. Thus, the light blocking layer 40 removes such light as would otherwise be noise for the camera 36, and effectively transmits only such light as should be detected, and this allows the camera 36 to operate at its best performance.

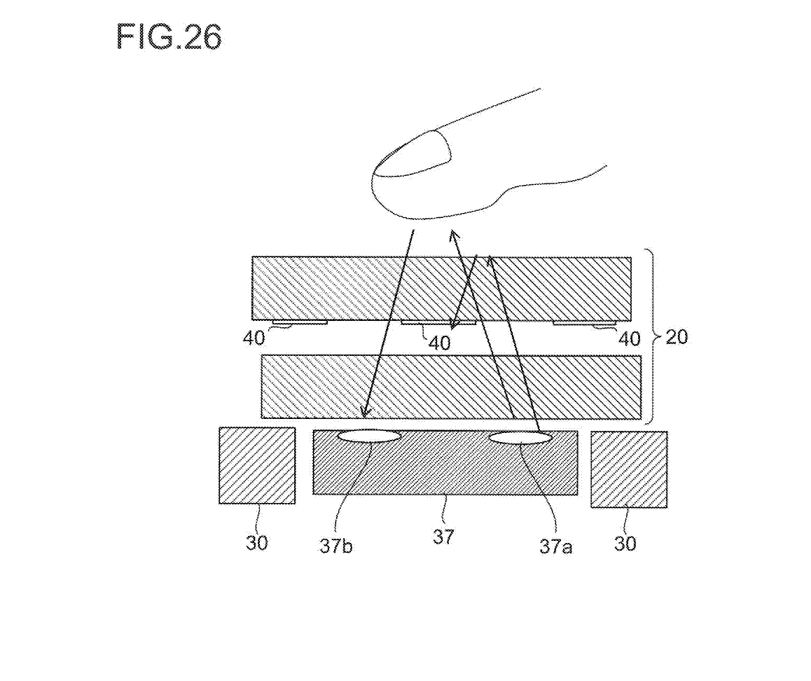

FIG. 25 is a see-through top view illustrating the vicinity of a light blocking layer of another example of the present embodiment; and FIG. 26 is a sectional view taken from FIG. 25. As illustrated in FIG. 25 and FIG. 26, a light blocking layer 40 has a rectangular outer contour and an inner contour that is consisted of two circular inner contours, and a proximity sensor 37 is disposed in an opening portion 34 of a light guide plate 31. And the outer contour of the light blocking layer 40 is larger than the opening portion 34. On the other hand, each of the two circular inner contours is smaller than the opening portion 34 and is smaller than the outer contour of the proximity sensor 37; specifically, each of the two circular inner contours is the same size as a light emitting portion 37a and a light receiving portion 37b of the proximity sensor 37.

With such a configuration, as indicated by arrows in FIG. 26, light emitted from the light emitting portion 37a to pass through an opening of the light blocking layer 40 is reflected on a user's finger to pass through another opening portion of the light blocking layer 40, and then is incident on the light receiving portion 37b. Unnecessary external light is blocked by the light blocking layer 40. Thus, the light blocking layer 40 removes such light as would otherwise be noise for the proximity sensor 37, and effectively transmits only such light as should be detected, and this allows the proximity sensor 37 to operate at its best performance.

The embodiments of the present invention is summarized below. A display apparatus 10 of one embodiment of the present invention includes an optical shutter device, a light guide plate 31 having a light emitting surface facing the optical shutter device and a light incident surface that is one of side surfaces that include neither the light emitting surface nor a surface opposing the light emitting surface, a light source (a light source unit 32) facing the light incident surface, and an opening portion 34 penetrating the light guide plate 31 from the light emitting surface through the surface opposing the light emitting surface, and a length X from the light incident surface to a center of the opening portion 34 is equal to or longer than half a length L from the light incident surface to a side surface opposing the light incident surface.

With this configuration, in the display apparatus 10, which employs an edge type backlight, it is possible to reduce uneven brightness around a non-display region 13 by disposing the opening portion 34 constituting the non-display region 13 as far as possible from the light source unit 32.

In this display apparatus 10, the optical shutter device may have a hole portion 27 facing the opening portion 34.

With this configuration, the transmitting characteristic of the non-display region 13 is improved.

Furthermore, in the display apparatus 10 described above, the light emitting surface or the surface opposing the light emitting surface may have a light extraction pattern which improves light extraction efficiency, and density of the light extraction pattern may be higher in the vicinity of side-surface-opposing-the-light-incident-surface-side part of the opening portion 34 than in part therearound.

With this configuration, the light extraction efficiency is improved in the vicinity of the side-surface-opposing-the-light-incident-surface-side part of the opening portion 34, and it is possible to reduce uneven brightness to a level insignificant in practical use.

Moreover, in the display apparatus 10 described above, the light emitting surface or the surface opposing the light emitting surface may have a light extraction pattern which improves light extraction efficiency, and density of the light extraction pattern may be lower in the vicinity of light-incident-surface-side part of the opening portion 34 than in part therearound.

With this configuration, the light extraction efficiency is lowered in the vicinity of the light-incident-surface-side part of the opening portion 34 than in part therearound, and it is possible to reduce uneven brightness to a level insignificant in practical use.

Furthermore, in the display apparatus 10 described above, there may be provided an insertion member inserted in the opening portion 34.

With this configuration, the opening portion 34 is filled with the insertion member, and this helps prevent leakage of light from inside the light guide plate 31 through the opening portion 34.

Moreover, in the display apparatus 10 described above, there may be provided a frame where the light guide plate 31 is mounted, and the insertion member may be a protrusion portion 35a that protrudes at least from the frame.

With this configuration, at a time of assembly, the light guide plate 31 is positioned and fixed by the protrusion portion 35a by means of the protrusion portion 35a being inserted and fitted in the opening portion 34.

Furthermore, in the display apparatus 10 described above, the insertion member may be at least a proximity sensor 37 or a camera 36.

With this configuration, the proximity sensor 37 or the camera 36 can be disposed within the display section 11, and the display section 11 can be made larger than in a case where the proximity sensor 37 or the camera 36 is disposed outside the display section 11. Alternatively, when the display section 11 is formed in the conventional size, it is possible to achieve a narrow frame that is narrower than a conventional frame by an amount of space for the camera 36 and the proximity sensor 37, and thus it is possible to achieve a compact display apparatus.

Moreover, in the display apparatus 10 described above, a light blocking layer 40 having a shape corresponding to an opening shape of the opening portion 34 may be disposed directly or indirectly on a light-emitting-surface side of the opening portion 34.

With this configuration, it is possible to make uneven brightness liable to occur around the non-display region 13 unnoticeable by blocking light there by means of the light blocking layer 40, and thus to improve the evenness of brightness in the display section 11. Moreover, by the light blocking layer 40 blocking light leaking through the opening portion 34, it is possible to improve the display quality with respect to viewing of the display section 11 from an oblique direction.

Furthermore, in the display apparatus 10 described above, an inner contour of the light blocking layer 40 may be smaller than the opening portion 34 and an outer contour of the light blocking layer 40 may be larger than the opening portion 34.

With this configuration, it is possible to improve the display quality with respect to viewing of the display section 11 from an oblique direction, and to make the proximity sensor 37 and the camera 36 operate at their best performance.

### INDUSTRIAL APPLICABILITY

The present invention is applicable to a display apparatus employing an optical shutter device such as a liquid crystal panel, MEMS, or the like and employing an edge type backlight, and can be used in a narrow-framed smart phone, for example.

### LIST OF REFERENCE SIGNS

10 display apparatus

20 liquid crystal panel (optical shutter device)

27 hole portion

31 light guide plate

31a region (vicinity of surface-opposing-light-incident-surface side of opening portion)

31b region (vicinity of light-incident-surface side of opening portion)

32 light source unit (light source)

34 opening portion

35 backlight chassis (frame)

35a protrusion portion

36 camera

37 proximity sensor

40 light blocking layer

1. A display apparatus comprising:
an optical shutter device;
a light guide plate having a light emitting surface facing the optical shutter device and a light incident surface that is one of side surfaces that include neither the light emitting surface nor a surface opposing the light emitting surface;
a light source facing the light incident surface; and
an opening portion penetrating the light guide plate from the light emitting surface through the surface opposing the light emitting surface,
wherein
a light extraction pattern that improves light extraction efficiency is disposed on the light emitting surface or on the surface opposing the light emitting surface,
density of the light extraction pattern is higher in vicinity of side-surface-opposing-the-light-incident-surface-side part of the opening portion than in part therearound, and
a length from the light incident surface to a center of the opening portion is equal to or longer than half a length from the light incident surface to a side surface opposing the light incident surface.

2. The display apparatus according to claim 1,
wherein
the optical shutter device has a hole portion facing the opening portion.

3. The display apparatus according to claim 1, further comprising
an insertion member inserted in the opening portion.

4. The display apparatus according to claim 3, further comprising
a frame where the light guide plate is mounted,
wherein
the insertion member is a protrusion portion protruding at least from the frame.

5. The display apparatus according to claim 3,
wherein
the insertion member is at least a proximity sensor or a camera.

6. The display apparatus according to claim 1,
wherein
a light blocking layer having a shape corresponding to an opening shape of the opening portion is disposed directly or indirectly on a light-emitting-surface side of the opening portion.

7. The display apparatus according to claim 6,
wherein
an inner contour of the light blocking layer is smaller than the opening portion, and an outer contour of the light blocking layer is larger than the opening portion.

8. A display apparatus comprising:
an optical shutter device;
a light guide plate having a light emitting surface facing the optical shutter device and a light incident surface that is one of side surfaces that include neither the light emitting surface nor a surface opposing the light emitting surface;
a light source facing the light incident surface; and
an opening portion penetrating the light guide plate from the light emitting surface through the surface opposing the light emitting surface,
wherein
a light extraction pattern that improves light extraction efficiency is disposed on the light emitting surface or on the surface opposing the light emitting surface,
density of the light extraction pattern is lower in vicinity of light-incident-surface-side part of the opening portion than in part therearound, and
a length from the light incident surface to a center of the opening portion is equal to or longer than half a length from the light incident surface to a side surface opposing the light incident surface.

9. The display apparatus according to claim 8,
wherein
the optical shutter device has a hole portion facing the opening portion.

10. The display apparatus according to claim 8, further comprising
an insertion member inserted in the opening portion.

11. The display apparatus according to claim 10, further comprising
a frame where the light guide plate is mounted,
wherein
the insertion member is a protrusion portion protruding at least from the frame.

12. The display apparatus according to claim 10,
wherein
the insertion member is at least a proximity sensor or a camera.

13. The display apparatus according to claim 8,
wherein
a light blocking layer having a shape corresponding to an opening shape of the opening portion is disposed directly or indirectly on a light-emitting-surface side of the opening portion.

14. The display apparatus according to claim 13,
wherein
an inner contour of the light blocking layer is smaller than the opening portion, and an outer contour of the light blocking layer is larger than the opening portion.
